(19) United States
(12) Patent Application Publication
(10) Pub. No.: US 2017/0090914 A1
(43) Pub. Date: Mar. 30, 2017

(54) METHOD AND SYSTEM FOR ASSOCIATING APPLICATIONS USING PARAMETER OPTIMIZATION

(71) Applicant: SVG Media Pvt Ltd, New Delhi (IN)

(72) Inventors: Vaibhav PANDEY, Gurgaon (IN); Siddharth PURI, Gurgaon (IN)

(21) Appl. No.: 15/063,622

(22) Filed: Mar. 8, 2016

(30) Foreign Application Priority Data
Sep. 24, 2015 (IN) 3051/DEL/2015

(51) Int. Cl. G06F 9/44

(52) U.S. Cl. CPC G06F 8/70

(57) ABSTRACT

A computer implement method associates plural applications and receives an application programming interface associated with each of the applications with a processor. The computer-implemented method also unifies the received application programming interface associated with each of the applications with the processor. The computer-implemented method also classifies the application programming interface associated with each of the applications into a corresponding category. The computer-implemented method also associates the application programming interface associated with each of the applications based on the classification and a pre-determined set of rules to be used by a processor. The association is done by cross linking the application programming interface associated with each of the applications.

### INTRODUCTION

The present invention relates to the field of mobile applications. More specifically, the present disclosure relates to a method and system for associating a plurality of applications.

With the advent in technological advancements, online service providing has become one of the leading businesses in the last few years. These services include various on demand services such as food based services, travelling based services, housing services and the like. Further, each application belongs to a specific class or category of service. In general, these services are provided to users through various online mobile applications. These mobile applications can be accessed through various types of communication devices. These communication devices include smart phone, tablet, laptop and the like. These services cater to the different needs of the users.

Further, these services are being provided by numerous online developers and companies related to the online service providing business. These companies provide their services and products for marketing purposes and revenue generation. The revenue is generated based on an amount charged by these companies when the users avail the services. Each service has a corresponding price based on geographical factors, demographical factors and the like. In general, the revenue is generated when the users access these mobile applications and avail the services of their choice.

Going further, these mobile applications are developed through an application programming interface. The application programming interface sets the groundwork for these mobile applications. In general, the application programming interface is a set of routines, protocols and tools which are used by various application developers to develop the mobile applications. Nowadays, many application developers or providers have started providing their application programming interfaces to other developers to some extent. The application developers allow other developers to utilize their application programming interface for running their business. For example, an application developer may utilize Google Maps API on their application for providing real time directions for users. Moreover, these are open source APIs which can be used by various application developers for building their application.

Nowadays, many application developers or providers have started providing their application programming interfaces for their applications to other application developers to some extent. The application developers allow other developers to utilize their application programming interface for running their business. For example, an application developer may utilize Google Maps API on their application for providing real time directions for users. Moreover, these are open source APIs which can be used by various application developers for building their application.

Presently, many companies have not allowed their application programming interfaces to be utilized by other developers. However, a number of companies have started dealing exclusively with other companies by enabling them to utilize or link their application programming interface in their applications. The companies have started linking their application programming interfaces with the applications programming interfaces of other companies. Moreover, a single application developer may provide its application programming interface to more than one company based on their choice. In addition, the company needs to physically approach all the companies with whom it wants to deal with. Further, the sharing of application programming interfaces is done for maximizing revenue. The companies dealing in sharing of their application programming interfaces share the profit as well based on a mutual contract between them.

The existing systems and methods for linking various application programming interfaces with each other are inefficient. There is no such platform present in the art which reduces the need for the application providers to physically approach other application providers in order to deal with them. Moreover, the application developers have no idea about which type of application programming interface they should link with in order to generate more revenue. The present systems and methods do not allow the application developers to optimize or define various parameters associated with the applications in order to link with applications of their choice. There is no such system available in the art which recommends the application developers with application programming interfaces of their choice for linking. In addition, the present systems and methods do not provision the application developers to define a particular location, time or price in order to link with other applications. Furthermore, the application developers do not have the provision to choose between a set of application programming interfaces for linking. This leads to wastage of time and investment and results in loss of business.

In the light of the above stated discussion, there is a need for system that overcomes the above stated disadvantages.

### SUMMARY

In one aspect, the present disclosure provides a computer-implemented method for optimization of a plurality of parameters associated with a plurality of applications. The plurality of parameters is optimized by a plurality of application developers. The computer-implemented method collects one or more inputs for the plurality of parameters from each of the plurality of application developers with a processor. In addition, the computer-implemented method optimizes the collected plurality of parameters for each of the plurality of application developers with the processor. Moreover, the computer-implemented method recommends one or more application programming interfaces to each of the plurality of application developers based on the optimized plurality of parameters. Further, the one or more inputs are collected in real time. Furthermore, the optimization is done for allowing each of the plurality of application developers to define one or more preferences associated with the plurality of parameters. Also, the recommendation is done in the real time.

In another embodiment, the computer-implemented method further associates the recommended one or more application programming interfaces with an application programming interface. The application programming interface is associated with each of the plurality of application developers.

In another embodiment, an application programming interface associated with a first category of application is associated with a recommended plurality of application programming interfaces. The recommended plurality of application programming interfaces is associated with a plurality of categories of applications. The first category of application is distinct from each of the plurality of categories of application. The association is done based on a choice of each of the plurality of application developers.

In another embodiment, the computer-implemented method further determines the one or more application programming interfaces based on the optimized plurality of parameters.

In another embodiment, the computer-implemented method further registers each of the plurality of application developers. The registration is done for allowing each of the plurality of application developers to provide the one or more inputs.

In another embodiment, the computer-implemented method further receives the application programming interface associated with each of the plurality of applications. The application programming interface is received from a corresponding application server of a plurality of application servers. In addition, the application programming interface is received for unification of the application programming interface associated with each of the plurality applications.

In another embodiment, the computer-implemented method further classifies the application programming interface into a corresponding category of application of one or more categories of applications.

In another embodiment, the plurality of parameters includes a range of price associated with one or more services associated with each of the plurality of applications. In addition, the plurality of parameters includes a range of timings between which the one or more services associated with each of the plurality of applications is available. Moreover, the plurality of parameters includes one or more locations at which the one or more services associated with each of the plurality of applications is available.

In another embodiment, each of the plurality of parameters is defined by an administrator. In another embodiment, the computer-implemented method further stores the application programming interface associated with each of the plurality of applications. In addition, the computer-implemented method stores registration information associated with each of the plurality of application developers and each of the classified application programming interfaces. Moreover, the computer-implemented method stores each of the recommended one or more application programming interfaces and each of the associated application programming interfaces. Further, the computer-implemented method stores the collected one or more inputs associated with the plurality of parameters.

In another aspect, the present disclosure provides a computer-program product for optimization of a plurality of parameters associated with a plurality of applications. The plurality of parameters is optimized by a plurality of application developers. The computer-program product includes a computer readable storage medium. The computer readable storage medium has a computer program stored thereon. The computer-program product collects one or more inputs for the plurality of parameters from each of the plurality of application developers. In addition, the computer-program product optimizes the collected plurality of parameters for each of the plurality of application developers. Moreover, the computer-program product recommends one or more application programming interfaces to each of the plurality of application developers based on the optimized plurality of parameters. Further, the one or more inputs are collected in real time. Furthermore, the optimization is done for allowing each of the plurality of application developers to define one or more preferences associated with the plurality of parameters. Also, the recommendation is done in the real time.

In another embodiment, the computer-program product further associates the recommended one or more application programming interfaces with an application programming interface. The application programming interface is associated with each of the plurality of application developers.

In another embodiment, an application programming interface associated with a first category of application is associated with a recommended plurality of application programming interfaces. The recommended plurality of application programming interfaces is associated with a plurality of categories of applications. The first category of application is distinct from each of the plurality of categories of application. The association is done based on a choice of each of the plurality of application developers.

In yet another aspect, the present disclosure provides a system for optimization of a plurality of parameters associated with a plurality of applications. The plurality of parameters is optimized by a plurality of application developers. The system includes a collection module in a processor. The collection module collects one or more inputs for the plurality of parameters from each of the plurality of application developers. In addition, the system includes an optimization engine in the processor. The optimization engine optimizes the collected plurality of parameters for each of the plurality of application developers. Moreover, the system includes a recommendation engine in the processor. The recommendation engine recommends one or more application programming interfaces to each of the plurality of application developers based on the optimized plurality of parameters. Further, the one or more inputs are collected in real time. Furthermore, the optimization is done for allowing each of the plurality of application developers to define one or more preferences associated with the plurality of parameters. Also, the recommendation is done in the real time.

In another embodiment, the system further includes an association module in the processor. The association module associates the recommended one or more application programming interfaces with an application programming interface. The application programming interface is associated with each of the plurality of application developers.

In another embodiment, the system further includes a determination module in the processor. The determination module determines the one or more application programming interfaces based on the optimized plurality of parameters.

In another embodiment, the system further includes a registration module in the processor. The registration module registers each of the plurality of application developers. The registration is done for allowing each of the plurality of application developers to provide the one or more inputs.

In another embodiment, the system further includes a receiving module in the processor. The receiving module receives the application programming interface associated with each of the plurality of applications. The application programming interface is received from a corresponding application server of a plurality of application servers. In addition, the application programming interface is received for unification of the application programming interface associated with each of the plurality applications.

In another embodiment, the system further includes a classification engine in the processor. The classification engine classifies the application programming interface into a corresponding category of application of one or more categories of applications.

In another embodiment, the system further includes a database in the processor. The database stores the application programming interface associated with each of the plurality of applications. In addition, the database stores registration information associated with each of the plurality of application developers and each of the classified application programming interfaces. Moreover, the database stores each of the recommended one or more application programming interfaces and each of the associated application programming interfaces. Further, the database stores the collected one or more inputs associated with the plurality of parameters.

### BRIEF DESCRIPTION OF THE DRAWINGS

Having thus described the invention in general terms, reference will now be made to the accompanying drawings, which are not necessarily drawn to scale, and wherein:

FIG. 1A and FIG. 1B illustrate a general overview of a system for optimization of a plurality of parameters associated with one or more applications, in accordance with various embodiments of the present disclosure;

FIG. 2 illustrates a block diagram of a communication device, in accordance with various embodiments of the present disclosure;

FIG. 3A illustrates a block diagram for showing an example of association based on optimization of the plurality of parameters, in accordance with various embodiments of the present disclosure;

FIG. 3B illustrates a portable communication device for showing the association based on the optimization of the plurality of parameters, in accordance with various embodiments of the present disclosure; and

FIG. 4 illustrates a flowchart for the optimization of the plurality of parameters associated with the one or more applications, in accordance with various embodiments of the present disclosure.

It should be noted that the accompanying figures are intended to present illustrations of exemplary embodiments of the present disclosure. These figures are not intended to limit the scope of the present disclosure.

### DETAILED DESCRIPTION

In the following description, numerous specific details are set forth to provide a thorough understanding of the present invention. It will be apparent, however, to one skilled in the art that the present invention can be practiced broadly without these specific details. In some instances, structures and devices are shown in block diagram form to provide clarity and to avoid obscuring aspects the present invention.

Reference below to “one embodiment” or “an embodiment” means that a particular feature, structure, or characteristic is included in at least one embodiment of the present invention. The appearance of the phrase “in one embodiment” below does not necessarily refer to the same embodiment, nor are separate or alternative embodiments mutually exclusive. The intent is that a feature of one embodiment may be present alone or in combination with features of other embodiments. Similarly, various described requirements may be applicable to some embodiments but not all embodiments.

Moreover, although the following description contains details for the purpose of describing the invention to meet the pertinent requirements of the U.S. patent Statute, those skilled in the art will appreciate that many variations of the invention are possible, and are within the scope of this description and the invention. Similarly, although many of the features of the present invention are described in terms of each other, or in conjunction with each other, those skilled in the art will appreciate that many of these features can be used independently. Accordingly, this description meets the requirement of the U.S. patent Statute, but, where appropriate, is intended to be exemplary, allowing for variations to, and without imposing limitations upon, the present invention.

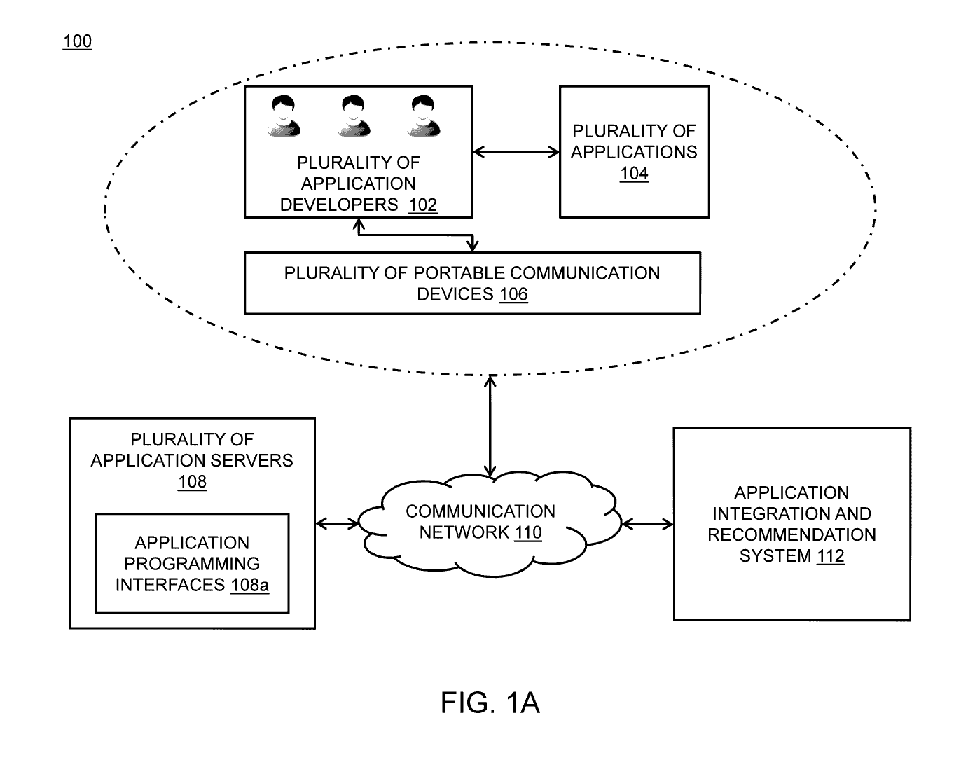

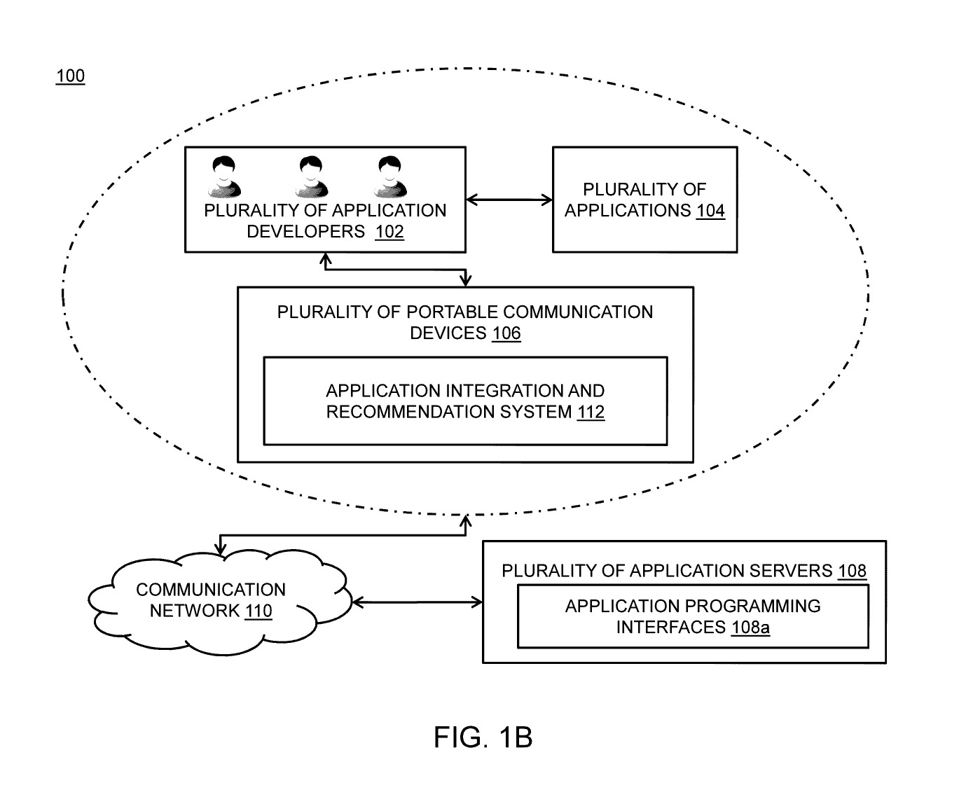

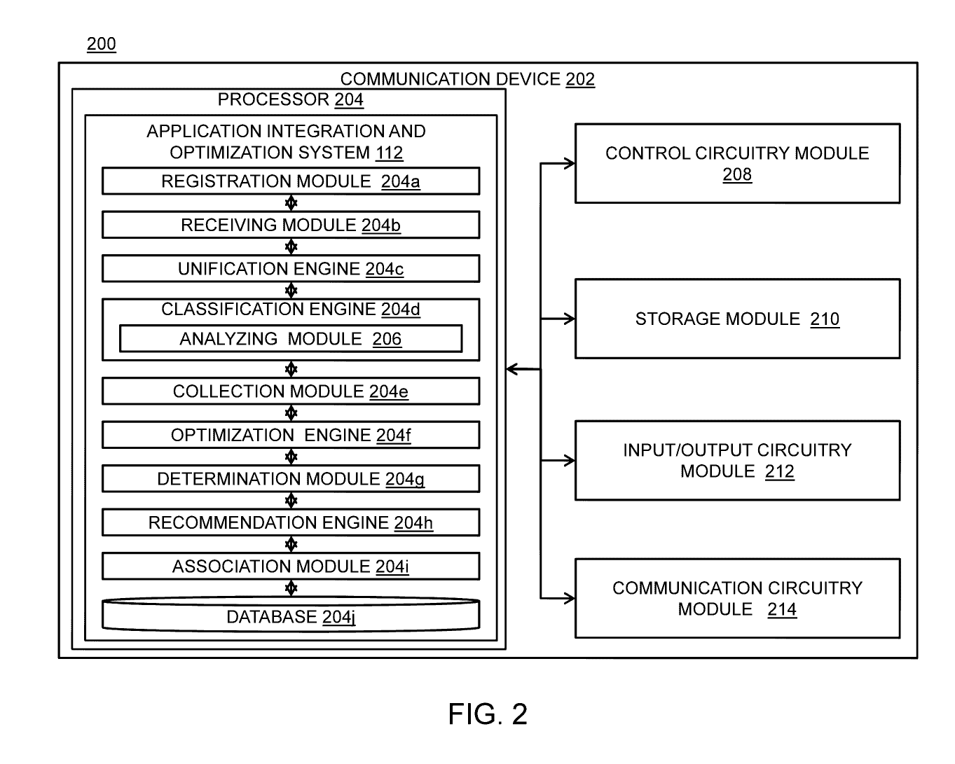

FIG. 1A illustrates a general overview of a system 100 for optimization of a plurality of parameters associated with one or more applications, in accordance with various embodiments of the present disclosure. The system 100 is configured for optimization of the plurality of parameters for recommendation of one or more application programming interfaces associated with the corresponding one or more applications. Also, the system 100 recommends the one or more application programming interfaces to one or more application developers associated with the corresponding one or more applications. Moreover, the system 100 is configured to optimize the plurality of parameters associated with the one or more applications for association of the one or more application programming interfaces with another application programming interface (elaborated in the detailed description of FIG. 2).

Going further, the system 100 includes a plurality of portable communication devices 104, a plurality of applications 106, a plurality of application servers 108, a communication network 110 and an application integration and optimization system 112. In addition, the application integration and optimization system 112 performs optimization of the plurality of parameters associated with the corresponding one or more applications. Moreover, the application integration and optimization system 112 recommends the one or more application programming interfaces to the one or more application developers.

In addition, the plurality of applications 104 is associated with a corresponding plurality of application developers 102. In an embodiment of the present disclosure, an application of the plurality of applications 104 is associated an application developer of the plurality of application developers 102. Moreover, each of the plurality of application developers 102 corresponds to any person who is employed in development of one or more mobile applications. In an embodiment of the present disclosure, each of the plurality of application developers 102 is any person who utilizes the one or more application programming interfaces for developing the corresponding plurality of applications 104.

Moreover, each of the plurality of application developers 102 develops an on-demand service application for providing services to one or more users. The plurality of application developers 102 control functioning of the corresponding plurality of applications 104 in real time. For example, each of the plurality of application developers 102 is a software developer or coder having excess knowledge and information for building the corresponding plurality of applications 104. Moreover, the plurality of application developers 102 builds the corresponding plurality of applications 104 on a specific platform.

Further, each the plurality of applications 104 correspond to a mobile application configured to run on one or more portable communication devices. Examples of the one or more portable communication devices include a smart phone, a tablet, a laptop, a smart watch and the like. Moreover, each of the plurality of applications 104 is associated with a corresponding operating system of a plurality of operating systems. The plurality of operating systems include but may not be limited to an Android operating system, iOS, Windows operating system, Bada operating system, Symbian operating system and the like. In addition, the plurality of applications 104 associated with the specific type of the operating system run on a specific type of the one or more portable communication devices belonging to the same specific type of the operating system. Also, each of the one or more portable communication devices is associated with a user of the one or more users. The user corresponds to any person who owns a portable communication device for utilizing various services provided by the plurality of applications 102.

Furthermore, each of the one or more communication devices is connected to the internet in real time. Also, each of the one or more portable communication devices is associated with the corresponding user of a plurality of users who access one or more applications of the plurality of applications 104. The plurality of applications 104 is installed on the corresponding one or more portable communication devices. In an embodiment of the present disclosure, a number of applications of the plurality of applications 104 are installed in the one or more of portable communication devices based on a choice of the plurality of users.

In addition, each of the plurality of applications 104 is an on demand service application. Further, type of the on demand service applications include one or more taxi service applications, one or more food based service applications and one or more travel planning based applications. Moreover, the type of the on demand service applications include one or more home service based applications and other one or more applications known in the art. For example, a user may access a taxi based application for booking a taxi or another user may access a food based application for booking a seat in a restaurant.

Further, the plurality of application developers 102 is associated with the corresponding plurality of portable communication devices 106. In an embodiment of the present disclosure, each of the plurality of application developers 102 is associated with a corresponding portable communication device of the plurality of portable communication devices 106. Also, each of the plurality of application developers 102 owns the corresponding portable communication device of the plurality of portable communication devices 106. The plurality of portable communication devices 106 include but may not be limited to a laptop, a desktop computer, a smart phone, a tablet and a personal digital assistant.

Furthermore, the portable communication device of the plurality of portable communication device 106 is utilized by the corresponding application developer of the plurality of application developers 102 for working on development of the corresponding application of the plurality of applications 104. Also, each of the plurality of application developers 102 built the corresponding application of the plurality of applications 104 on a specific platform. The platform includes an android platform, a windows platform, an IOS platform and the like based on a choice of the plurality of application developers 102. Also, each of the plurality of portable communication devices 106 is connected to the internet in real time.

Moreover, each of the plurality of application developers 102 build the application of the plurality of applications 104 on particular software application installed on the corresponding plurality of portable communication devices 106. The software application corresponds to any application dedicated for allowing building of the plurality of applications 104. In an embodiment of the present disclosure, the software application is dedicated for building the application for the specific type of the operating system. Further, each of the plurality of portable communication devices 106 allow each of the plurality of developers 102 to interface with the application integration and optimization system 112. In an embodiment of the present disclosure, each of the plurality of application developers 102 interfaces by registering on the application integration and optimization system 112 (as elaborated in the detailed description of FIG. 2).

Furthermore, each of the plurality of application developers 102 interfaces with the application integration and optimization system 112 for optimizing the plurality of parameters associated with the application of the plurality of applications 104. Moreover, each of the plurality of application developers 102 utilizes the portable communication device of the plurality of portable communication devices 106 for viewing the recommended one or more application programming interfaces based on the optimized plurality of parameters (as elaborated in the detailed description of FIG. 2). Each of the plurality of application developers 102 may or may not utilize a different device for viewing the recommended one or more application programming interfaces and a different device for building the plurality of applications 104.

Going further, each of the plurality of applications 104 is associated with an application server of the corresponding plurality of application servers 108. Also, the application of the plurality of applications 104 is stored in the corresponding application server of the plurality of application servers 108. Moreover, each application server of the plurality of application servers 108 is configured to run the corresponding application of the plurality of applications 104. In addition, the plurality of application servers 108 handles all related operations between the plurality of users and an organization's backend business applications. Moreover, each of the plurality of application servers 108 is remotely located from each other.

Moreover, each of the plurality of application servers 108 is operated or controlled by the corresponding application developer of the plurality of application developers 102 associated with the application of the plurality of applications 104. In an embodiment of the present disclosure, each of the plurality of application servers 108 is controlled or monitored by a corresponding application administrator at a remote location. In addition, the plurality of application servers 108 is associated with application programming interfaces 106a. In an embodiment of the present disclosure, the application programming interfaces 108a are stored on the plurality of application servers 108. In an embodiment of the present disclosure, each application programming interface of the application programming interfaces 108a is associated with the corresponding application of the plurality of applications 104 stored in the corresponding application server of the plurality of application servers 108.

Further, each of the plurality of applications 104 are based on a specific application programming interface designed for a specific type or category of application. The application programming interface is a set of commands, functions and protocols used by the plurality of application developers 102 for utilizing one or more pre-defined functions for building the one or more applications for the specific type of operating system. In an embodiment of the present disclosure, each of the application programming interfaces 108a is an open application programming interface based on a pre-determined criterion (as mentioned below in the patent application).

In addition, the plurality of application developers 102 associated with the corresponding plurality of applications 104 allow or enable their corresponding application programming interfaces 108a to be open and utilized by other application developers for running their business. Moreover, the one or more application developers of the plurality of application developers 102 may allow an exclusive access of their application programming interfaces 108a to other one or more application providers or developers based on an exclusive dealing between the one or more application developers 102 and the other one or more application providers or developers (as described below in the detailed description of FIG. 2).

Further, each of the application programming interfaces 108a is associated with a specific key. In an embodiment of the present disclosure, each of the plurality of application developers 102 allow the other one or more application providers or developers to utilize their application programming interface by providing the specific key. The specific key is provided for gaining access to the application programming interfaces 108a and utilizing the key for business purposes. Furthermore, the key is an application programming interface key which is a code passed for identifying a calling program and the corresponding application developer. In addition, the application programming interface key is used for tracking and controlling how the application programming interface is used.

Moreover, each of the application programming interfaces 108a is identified using the application programming interface key. Also, the application programming interface key for each of the application programming interfaces 108a is stored in the corresponding application server of the plurality of application servers 108. In addition, the application programming key is fetched from the application server of the corresponding plurality of application servers 108 for gaining access to the application programming interface of the application programming interfaces 108a.

Going further, each of the plurality of application servers 108 is associated with the communication network 110. In an embodiment of the present disclosure, each application of the plurality of applications 104 is associated with the corresponding application server of the plurality of application servers 108 through the communication network 110. Moreover, the communication network 110 enables a medium for transfer of information between each of the plurality of applications 104 and each of the plurality of application servers 108. In an embodiment of the present disclosure, the communication network 110 enables working of the each of the plurality of applications 104.

Further, the medium for communication may be infrared, microwave, radio frequency (RF) and the like. The communication network 110 include but may not be limited to a local area network, a metropolitan area network, a wide area network, a virtual private network, a global area network, a home area network or any other communication network presently known in the art. The communication network 110 is a structure of various nodes or communication devices connected to each other through a network topology method. Examples of the network topology include a bus topology, a star topology, a mesh topology and the like. Accordingly, the one or more services provided by each of the plurality of applications 104 are accessed by the plurality of users through the communication network 110. Further, each of the plurality of applications 104 is connected to the internet through the communication network 110. Also, the communication network 110 enables each of the plurality of portable communication devices 106 to connect to the internet.

Moreover, each of the plurality of applications 104 is associated with the application integration and recommendation system 110. In an embodiment of the present disclosure, each of the plurality of applications 104 is associated with the application integration and recommendation system 110 through the communication network 108. In addition, each of the plurality of application servers 106 is associated with the application integration and recommendation system 110. Further, each of the plurality of application servers 106 is associated with the application integration and recommendation system 110 through the communication network 108.

Going further, the application integration and optimization system 112 is linked with each of the plurality of application servers 104. In addition, each of the plurality of application developers 102 associated with the corresponding plurality of application servers 106 enable or allow the application integration and optimization system 112 to fetch one or more information from each of the plurality of application servers 106 (as mentioned below in the patent application). Moreover, the application integration and optimization system 112 performs the optimization of the plurality of parameters for enabling recommending of the one or more application programming interfaces to each of the plurality of application developers 102.

In addition, the application integration and optimization system 112 includes a central server for performing one or more operations for the optimizing of the plurality of parameters associated with each of the plurality of applications 104. Further, each of the plurality of application developers 102 is provided an access to the application integration and optimization system 112. In an embodiment of the present disclosure, the access is provided through a web-based interface on the corresponding portable communication device of the plurality of portable communication devices 106. The web-based interface is provided by the application integration and optimization system 112. Moreover, the web-based interface is provided through a website of the application integration and optimization system 112 on each of the plurality of portable communication devices 106. In an embodiment of the present disclosure, the web-based interface is provided through a mobile application on the corresponding plurality of portable communication devices 106.

In addition, the web-based interface is provided for enabling each of the plurality of application developers 102 to optimize the plurality of parameters associated with the corresponding application of the plurality of applications 104. Also, the web-based interface is provided for allowing each of the plurality of application developers 102 to view the recommended one or more application programming interfaces in real time. The web-based interface provides one or more options to each of the plurality of application developers 102 for choosing to link with an application programming interface of the recommended one or more application programming interfaces based on the optimized plurality of parameters. Furthermore, each of the plurality of application developers 102 registers by providing various credentials on the application integration and optimization system 112 (as described below in the patent application).

In addition, the application integration and optimization system 112 optimizes the plurality of parameters for enabling the linking of the one or more application programming interfaces with other application programming interfaces. Further, the application integration and optimization system 112 is a platform for enabling the one or more application developers to optimize the plurality of parameters in order to link with application programming interfaces which are relevant. Furthermore, the application integration and optimization system 112 enables the one or more application developers to optimize the plurality of parameters for manually choose linking with various other one or more application programming interfaces.

Further, the application integration and optimization system 112 is configured to fetch the application programming interface associated with each of the plurality of applications 104 (as described below in the patent application). Furthermore, the application integration and optimization system 112 is configured to consolidate the application programming interface associated with each of the plurality of applications 104 (as mentioned below in the patent application). Moreover, the application integration and optimization system 112 is configured to perform categorization of each of the application programming interfaces 108a into a corresponding distinct category of applications of one or more categories of applications (as described below in the detailed description of FIG. 2).

Further, the application integration and optimization system 112 is configured to store a set of information associated with one or more operations performed by each of one or more components of the application integration and optimization system 112 (as described below in the patent application). The application integration and optimization system 112 enables unification of the application programming interfaces 108a associated with the corresponding plurality of applications 104. The application integration and optimization system 112 enables the application of the plurality of applications 104 to utilize the one or more services or features of other one or more application of the plurality of applications 104 at the same time (as described in detail in the detailed description of FIG. 2). The application integration and optimization system 112 finds a best match of the application programming interface for each application developer of the one or more application developers 102 based on the optimized plurality of parameters.

It may be noted that in FIG. 1A, the application of the plurality of applications 104 is associated with the application developer of the plurality of application developers 102; however, those skilled in the art would appreciate that there are more number of applications associated with the application developer of the plurality of application developers 102. Further, it may be noted that in FIG. 1, the application server of the plurality of application servers 106 is associated with the corresponding application of the plurality of applications 104; however, those skilled in the art would appreciate that there more number of applications associated with a single application server.

In an embodiment of the present disclosure, as illustrated in FIG. 1B, the application integration and optimization system 112 is a part of the plurality of portable communication devices 106. In an embodiment of the present disclosure, the application integration and optimization system 112 is installed on each of the plurality of portable communication devices 106. The application integration and optimization system 112 is a platform for allowing each of the plurality of application developers to optimize the plurality of parameters associated with the corresponding plurality of applications 104. In an embodiment of the present disclosure, the application integration and optimization system 112 is installed as a mobile application on each of the plurality of portable communication devices 106. In another embodiment of the present disclosure, the application integration and optimization system 112 is the website providing the web-based interface to the plurality of application developers 102.

Each of the plurality of application developers 102 access the application integration and optimization system 112 on the corresponding portable communication device of the plurality of portable communication devices 106. In an embodiment of the present disclosure, the plurality of application developers 102 accesses the mobile application of the application integration and optimization system 112. In another embodiment of the present disclosure, the plurality of application developers 106 accesses the web-based interface of the application integration and optimization system 112. Also, the plurality of application developers 102 registers on the application integration and optimization system 112 on the corresponding plurality of portable communication devices 106.

Each of the plurality of application developers 102 register by providing a set of information to the application integration and optimization system 112. The set of information includes personal information of each of the plurality of application developers 102 (name, age, gender and the like), professional information of each of the plurality of application developers 102 (name of current organization working in, work experience and the like), a name of the application of each of the plurality of application developers 102, a category of the application associated with each of the plurality of application developers 102 and the like.

The application integration and optimization system 112 stores the set of information provided by each of the plurality of application developers 102. The application integration and optimization system 112 provides a username and a password to each of the plurality of application developers 102. The username and the password are provided for logging in the application integration and optimization system 112. In addition, each of the plurality of application developers 102 continues the registration process by paying a pre-defined amount of money through the web-based interface of the application integration and optimization system 112. The plurality of application developers 102 may pay the pre-defined amount of money through a credit card, debit card, net banking and the like.

Further, the application integration and optimization system 112 performs the one or more operations based on a set of inputs provided by each of the plurality of application developers 102 (as stated below in the detailed description of the FIG. 2).

FIG. 2 illustrates a block diagram 200 of a communication device 202, in accordance with various embodiments of the present disclosure. The communication device 202 includes a processor 204, a control circuitry module 206, a storage module 208, an input/output circuitry module 210 and a communication circuitry module 212. In an embodiment of the present disclosure, the processor 204 includes one or more components of the application integration and optimization system 112. Further, the one or more components of the application integration and optimization system 112 includes a registration module 204a, a receiving module 204b, a unification engine 204c, a classification engine 204d, an analyzing module 206, a collection module 204e, an optimization engine 204f, a determination module 204g, a recommendation engine 204h, an association module 204i and a database 204j. It may be noted that to explain the system elements of FIG. 2, references have to be made to the system elements of FIG. 1A and FIG. 1B.

Each of the plurality of application developers 102 access a browser of one or more browsers for accessing the application integration and optimization system 112 on the corresponding portable communication device of the plurality of portable communication devices 106. In addition, each of the plurality of application developers 102 accesses the browser of the one or more browsers for accessing the web-based interface of the application integration and optimization system 112. In an embodiment of the present disclosure, each of the plurality of application developers 102 accesses the website of the application integration and optimization system 112 on the corresponding portable communication device of the plurality of portable communication devices 106.

Going further, the registration module 204a of the application integration and optimization system 112 is configured for enabling registration of each of the plurality of application developers 102. The registration is done for allowing each of the plurality of application developers 102 to provide one or more inputs. Moreover, the one or more inputs are provided for the corresponding plurality of parameters associated with each of the plurality of applications 104. Also, each of the plurality of application developers 102 provides the set of information for registering on the application integration and optimization system 112 (as described above in the detailed description of the FIG. 1B).

Each of the plurality of application developers 102 is provided with the username and the password after submitting the set of information on the application integration and optimization system 112 (as described above in the detailed description of the FIG. 1B). Further, each of the plurality of application developers 102 login to the application integration and optimization system 112 with the provided username and the password. Moreover, the receiving module 204b of the application integration and optimization system 112 is configured to receive the application programming interface associated with each of the plurality of applications 104. In addition, the application programming interface associated with each of the plurality of applications 104 are received in real time.

In an embodiment of the present disclosure, the application programming interface associated with each of the plurality of applications 104 are pre-fetched and stored in the application integration and optimization system 112. In an embodiment of the present disclosure, the fetching is immediately performed after each of the plurality of application developers 102 register on the application integration and optimization system 112. Further, the application programming interface are received from the corresponding application server of the plurality of application servers 108 associated with the corresponding application of the plurality of applications 104. In an embodiment of the present disclosure, the application programming interface associated with each of the plurality of applications 104 are received through the communication network 110. The application programming interface associated with each of the plurality of applications 104 is stored in a database associated with each of the plurality of application servers 108.

Moreover, each of the plurality of application developers 102 enables the application integration and optimization system 112 to fetch their corresponding application interface of the application programming interfaces 108a. In an embodiment of the present disclosure, each of the application programming interfaces 108a are open application programming interfaces for allowing the fetching of the application programming interface associated with each of the plurality of applications 104. Also, each of the application programming interfaces 108a is fetched from a remote location based on a location of each of the plurality of application servers 108.

For example, an application developer A accesses the application integration and optimization system 112 on a portable communication device D1 (say, a laptop) and an application developer B accesses the application integration and optimization system 112 on a portable communication device D2 (say, a desktop computer). Moreover, the application developer A is associated with an application A1 and the application developer B is associated with an application B1. Also, the application A1 is associated with an application programming interface AP1 and the application programming interface AP2. In addition, the application developer A and the application developer B provides the set of information for registering on the application integration and optimization system 112. Further, the receiving module 204b fetches the application programming interface AP1 associated with the application A1 from an application server S1 and the application programming interface AP2 associated with the application B1 from an application server S2.

Moreover, the unification engine 204c of the application integration and optimization system 112 is configured for consolidating the fetched application programming interface associated with each of the plurality of applications 104. In an embodiment of the present disclosure, the unification engine 204c accumulates the application programming interface associated with each of the plurality of applications 104. In addition, the consolidation is performed for allowing each of the plurality of application developers 102 to integrate their application programming interface on the application integration and optimization system 112.

Also, each application programming interface of the application programming interfaces 108a is associated with the distinct category of application of the one or more categories of applications. In addition, the unification engine 204c consolidates the application programming interfaces associated with each of the plurality of applications 104 at a single place. Also, the unification engine 204c selectively consolidates the application programming interface associated with each of the plurality of applications 104 based on the category of application associated with each of the application programming interfaces 108a.

Going further, the unification engine 204c unifies the application programming interface associated with each of the plurality of applications 104 if each of the plurality of applications 104 is the on demand service applications. In an embodiment of the present disclosure, the unification engine 204c does not consolidate the application programming interface associated with the one or more applications of the plurality of applications 104 which are not on demand service applications. The unification is done at regular intervals of time. In an embodiment of the present disclosure, the unification is done as soon as the application programming interface associated with each of the plurality of applications 104 are fetched from each of the plurality of application servers 108.

Going further, the classification engine 204d classifies the application programming interface into the corresponding category of application of the one or more categories of applications associated with the corresponding plurality of applications. 104. In an embodiment of the present disclosure, the classification engine 204d classifies the application programming interface associated with each of the plurality of applications 104 based on a specific distinct category of application associated with each of the plurality of applications 104.

Moreover, the specific distinct category of application corresponds to a specific category of on demand service applications. Accordingly, the categorization is performed based on a pre-defined list of categories of applications pre-stored in the application integration and optimization system 112. In an embodiment of the present disclosure, the classification engine 204d matches the category of application associated with the corresponding application of the plurality of applications 104 against the pre-defined list of categories of applications and categorizes the application programming interface based on the matching.

Furthermore, information associated with the category of application associated with the application programming interface associated with each of the plurality of applications 104 is fetched along with the application programming interfaces 108a. Also, the application programming interface associated with a same category of application are stored separately from other application programming interface associated with another same category of application. Further, the classification engine 204d includes the analyzing module 206 configured to analyze and determine the corresponding category of application for the application programming interface. In an embodiment of the present disclosure, the categorization of the application programming interface associated with each of the plurality of applications 104 is performed after the determination of the category of application associated with each of the plurality of applications 104. The category of application is determined by using the pre-defined list of categories of applications and the set of information stored in the application integration and optimization system 112.

In addition, the one or more categories of applications are provided by the corresponding plurality of application servers 108. Moreover, the one or more categories of applications are defined by the application developer associated with each of the plurality of applications 104 monitoring the corresponding application server of the plurality of application servers 108. In an embodiment of the present disclosure, the one or more categories of applications are defined by an administrator associated with the application integration and optimization system 112.

Continuing the above stated example, the unification engine 204c consolidates the application programming interface AP1 associated with the application A1 and the application programming AP2 associated with the application B1. Moreover, the classification engine 204d categorizes the application programming interface AP1 into a category of application C1 (say, a taxi service based application) and the application programming interface AP2 into a category of application C2 (food service based application).

Also, the application integration and optimization system 112 is configured to create a common application programming interface for each of the one or more application programming interfaces categorized into the corresponding distinct category of application. The one or more application programming interfaces associated with the similar category of application are unified and a single application programming interface is created. Moreover, the creation of the common application programming interface allows the application integration and optimization system 112 to enable a cross relationship between the one or more application programming interfaces associated with a first distinct category of application and the one or more application programming interfaces associated with a second distinct category of application.

Going further, the collection module 204e collects the one or more inputs associated with the plurality of parameters from each of the plurality of application developers 102. In addition, the one or more inputs are collected in real time. Moreover, each of the one or more inputs is entered by each of the plurality of application developers 102 through the corresponding portable communication device of the plurality of portable communication devices 106. Also, each of the plurality of parameters is defined by an administrator. Each of the plurality of application developers 102 enters the one or more inputs on the web-based interface of the application integration and optimization system 112.

The one or more inputs are provided based on a choice of each of the plurality of application developers 102. In addition, the plurality of parameters includes a range of price associated with one or more services associated with each of the plurality of applications 104. In addition, the plurality of parameters includes a range of timings between which the one or more services associated with each of the plurality of applications 104 is available. Moreover, the plurality of parameters includes one or more locations at which the one or more services associated with each of the plurality of applications 104 is available. Also, each application developer provides the one or more inputs for finding one or more applications which match or display close proximity to the one or more inputs. In an embodiment of the present disclosure, the one or more inputs are provided for linking with a most suitable category of application of the plurality of applications 102.

Further, the optimization engine 204f optimizes the collected plurality of parameters for each of the plurality of application developers 102. Furthermore, the optimization is done for allowing each of the plurality of application developers 102 to define one or more preferences associated with the plurality of parameters. In an embodiment of the present disclosure, the optimization engine 204f enables completion of the optimization of the plurality of parameters for each of the plurality of application developers 102.

In addition, the optimization engine 204f optimizes the plurality of parameters based on the one or more inputs received from each of the plurality of application developers 102. In an embodiment of the present disclosure, the plurality of parameters is optimized as soon as the one or more inputs are received from each of the plurality of application developers 102. Moreover, the optimization engine 204f optimizes a set of parameters of the plurality of parameters based on the one or more inputs received for only the set of parameters. In an embodiment of the present disclosure, the plurality of application developers 102 provides the one or more inputs for the set of parameters of the plurality of parameters.

Extending the above stated example, the collection module 204e receives a range of price P1 (say, 500-700) for a service V1, a range of time T1 (say, 10 am to 7 pm) for the service V1 and locations L1 (say, Delhi, Chandigarh, Mumbai and Bangalore) for the service V1 from the application developer A for the application A1. Also, the collection module 204e receives a range of price P2 (say, 400-900) for a service V2, a range of time T2 (say, 8 am to 5 pm) for the service V2 and locations L2 (say, Delhi, Chennai and Kolkata) from the application developer B for the application B1. Accordingly, the optimization engine 204f optimizes the range of price P1, the range of time T1 and the locations L1 for the application A1 and optimizes the range of price P2, the range of time T2 and the locations L2 for the application B1.

In addition, the determination module 204g determines the one or more application programming interfaces based on the optimized plurality of parameters. The determination module 204g analyzes the optimized plurality of parameters for each plurality of applications 104. Moreover, the determination module 204g searches for the application programming interfaces corresponding to the optimized plurality of parameters. In an embodiment of the present disclosure, the determination module 204g finds the application programming interfaces having close or similar one or more inputs for the plurality of parameters.

In an embodiment of the present disclosure, the application programming interfaces are pre-stored in the application integration and optimization system 112. Moreover, the determination module 204g searches the application programming interfaces in the pre-defined list of categories of applications. In an embodiment of the present disclosure, the determination module 204g searches in a selected number of the pre-defined list of categories of applications based on the one or more inputs associated with the plurality of parameters. Also, the determination module 204g makes a list of the application programming interfaces based on the one or more inputs associated with the plurality of parameters.

Further, the recommendation engine 204h recommends the one or more application programming interfaces to each of the plurality of application developers 102 based on the optimized plurality of parameters. Furthermore, the recommendation is done in real time. Moreover, the recommendation engine 204h provides the list of the one or more application programming to each of the plurality of application developers 102. Also, the recommendation engine 204h displays the one or more application programming interfaces to each of the plurality of application developers 102.

In an embodiment of the present disclosure, the recommended one or more application programming interfaces are displayed on the web-interface of the application integration and optimization system 112. Moreover, the one or more application programming interfaces is associated with the corresponding one or more categories of applications. Moreover, the recommendation engine 204h recommends the one or more application programming interfaces associated with the plurality of categories of applications to the application developers associated with each of the plurality of applications 104 based on the optimized plurality of parameters. The one or more application programming interfaces are recommended for allowing each of the plurality of application developers 102 to choose for linking with the one or more application programming interfaces of their choice in real time.

Each of the plurality of application developers 102 views the recommended one or more application programming interfaces on the corresponding portable communication device of the plurality of portable communication devices 106. The plurality of application developers 102 views the recommended one or more application programming interfaces on the website associated with the application integration and optimization system 112. In an embodiment of the present disclosure, each of the plurality of application developers 102 views the recommended one or more application programming interfaces on the mobile application associated with the application integration and optimization system 112.

Going further, the recommendation engine 204h includes a location based engine, a time based engine and a location based engine. Moreover, the location based engine takes into account the one or more locations provided as the one or more inputs for mapping the one or more application programming interfaces. The mapping is done for recommending the one or more applications providing the one or more services at the provided one or more locations desired by each of the plurality of application developers 102. The location based engine provides a feedback related to the one or more locations which are suitable for the application developer where the one or more services will generate larger revenue.

In addition, the time based engine takes into account the range of timings provided as the one or more inputs for mapping the one or more application programming interfaces. The mapping is done for recommending the one or more applications providing the one or more services between the provided ranges of timings desired by each of the plurality of application developers 102. The time based engine checks for the one or more applications which are having similar timings with the corresponding application for which the recommendation has to be performed. Moreover, the time based engine recommends the one or more application programming interfaces or the one or more applications which provide services during a desired range of timings for each of the corresponding application developer.

Further, the price based engine takes into account the range of price provided as the one or more inputs for mapping the one or more application programming interfaces. The mapping is done for recommending the one or more applications providing the one or more services between the provided ranges of prices desired by each of the plurality of application developers 102. Also, the price based engine checks the price associated with the one or more services provided by each of the distinct category of application which are suitable for linking with the corresponding application. The price based engine checks for the one or more applications which are having prices in similarity with the corresponding application for which the recommendation has to be done. Moreover, the price based engine recommends the one or more application which provides the one or more services at a particular desired range of prices for each of the corresponding application developer.

Further, the location base engine, the time based engine and the price based engine work collectively for recommending the one or more application programming interfaces to each of the plurality of application developers 102 based on the optimized plurality of parameters. The recommending is done based on the location and the price. In an embodiment of the present disclosure, the recommending is done based on the location and the time. In another embodiment of the present disclosure, the recommending is done based on the price and the time.

Moreover, the association module 204i associates of the recommended one or more application programming interfaces with the application programming interface associated with each of the plurality of application developers 102. The association is done by cross linking the recommended one or more application programming interfaces with the application programming interface. In addition, the association is done in real time. Further, the application programming interface associated with a first category of application is associated with the recommended plurality of application programming interfaces associated with the plurality of categories of applications. In an embodiment of the present disclosure, the first category of application is distinct from each of the plurality of categories of application. The cross linking is done based on a choice of each of the plurality of application developers 102.

Also, the application programming interface associated with the first category of application is cross linked with a recommended plurality of application programming interfaces associated with the plurality of categories of applications. Accordingly, the first category of application is distinct from each of the plurality of categories of application. In addition, each category of application of the plurality of categories of application is a distinct category of application. The cross linking is performed after a consent of each of the plurality of application developers 102 received through the web-based interface of the application integration and optimization system 112.

In addition, the association enables each application developer to utilize services of other application developers through their application programming interfaces in order to enable the plurality of users to access services of various applications on a single application. Moreover, the application integration and optimization system 112 enables each application developer to deal with another application developer through the application programming interfaces 108a.

Continuing the above stated example, the recommendation engine 204h recommends an application programming interface AP3, an application programming interface AP4 and an application programming interface AP5 to the application developer A based on the range of price P1, the range of time T1 and the locations L1 and recommends an application programming interface AP6, an application programming interface AP7 and an application programming interface AP8 to the application developer B range of price P2, the range of time T2 and the locations L2. Moreover, the association module 204i enables cross linking of the application programming interface AP3, the application programming interface AP4 and the application programming interface AP5 with the application programming interface AP1 associated with the application A1 the application developer A and enables cross linking of the application programming interface AP6, the application programming interface AP7 and the application programming interface AP8 with the application programming interface AP2 associated with the application B1 the application developer B.

Going further, the database 204j stores the application programming interface associated with each of the plurality of applications 104. In addition, the database 204j stores registration information associated with each of the plurality of application developers 102 and each of the classified application programming interfaces. Moreover, the database 204j stores each of the recommended one or more application programming interfaces and each of the associated application programming interfaces. Further, the database 204j stores the collected one or more inputs associated with the plurality of parameters.

It may be noted that in FIG. 2, various modules of the application integration and optimization system 112 are shown that illustrates the working of the application integration and optimization system 112; however those skilled in the art would appreciate that the application integration and optimization system 112 may have more number of modules that could illustrate overall functioning of the application integration and optimization system 112.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 202 can be a desktop computer.

From the perspective of this disclosure, the control circuitry module 208 includes any processing circuitry or processor operative to control the operations and performance of the communication device 202. For example, the control circuitry module 208 may be used to run operating system applications, firmware applications, media playback applications, media editing applications, or any other application. In an embodiment, the control circuitry module 208 drives a display and process inputs received from the user interface. From the perspective of this disclosure, the storage module 210 includes one or more storage mediums including a hard-drive, solid state drive, flash memory, permanent memory such as ROM, any other suitable type of storage component, or any combination thereof. The storage module 210 may store, for example, media data (e.g., music and video files), application data (e.g., for implementing functions on the communication device 202).

From the perspective of this disclosure, the I/O circuitry module 212 may be operative to convert (and encode/decode, if necessary) analog signals and other signals into digital data. In an embodiment, the I/O circuitry module 210 may also convert the digital data into any other type of signal and vice-versa. For example, the I/O circuitry module 212 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 208, the storage module 210 or any other component of the communication device 202. It may be noted that the I/O circuitry module 212 is illustrated in FIG. 2 as a single component of the communication device 202; however those skilled in the art would appreciate that several instances of the I/O circuitry module 212 may be included in the communication device 202.

The communication device 202 may include any suitable interface or component for allowing the users to provide inputs to the I/O circuitry module 212. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism. In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly. In an embodiment, the I/O circuitry module 212 may include display circuitry for providing a display visible to the users. For example, the display circuitry may include a screen (e.g., an LCD screen) that is incorporated in the communication device 202. The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 208. Alternatively, the display circuitry may be operative to provide instructions to a remote display. In addition, the communication device 202 includes the communication circuitry module 214. The communication circuitry module 214 may include any suitable communication circuitry operative to connect to a communication network and to transmit communications (e.g., voice or data) from the communication device 202 to other devices within the communications network. The communication circuitry module 214 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 214 may be operative to create a communications network using any suitable communications protocol. For example, the communication circuitry module 214 may create a short-range communication network using a short-range communications protocol to connect to other devices. For example, the communication circuitry module 214 may be operative to create a local communication network using the Bluetooth,® protocol to couple the communication device 202 with a Bluetooth,® headset.

It may be noted that the computing device is shown to have only one communication operation; however, those skilled in the art would appreciate that the communication device 202 may include one more instances of the communication circuitry module 214 for simultaneously performing several communication operations using different communication networks. For example, the communication device 202 may include a first instance of the communication circuitry module 214 for communicating over a cellular network, and a second instance of the communication circuitry module 214 for communicating over Wi-Fi or using Bluetooth®.

In an embodiment of the present disclosure, the same instance of the communication circuitry module 214 may be operative to provide for communications over several communication networks. In an embodiment, the communication device 202 may be coupled to a host device for data transfers, syncing the communication device 202, software or firmware updates, providing performance information to a remote source (e.g., providing riding characteristics to a remote server) or performing any other suitable operation that may require the communication device 202 to be coupled to the host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

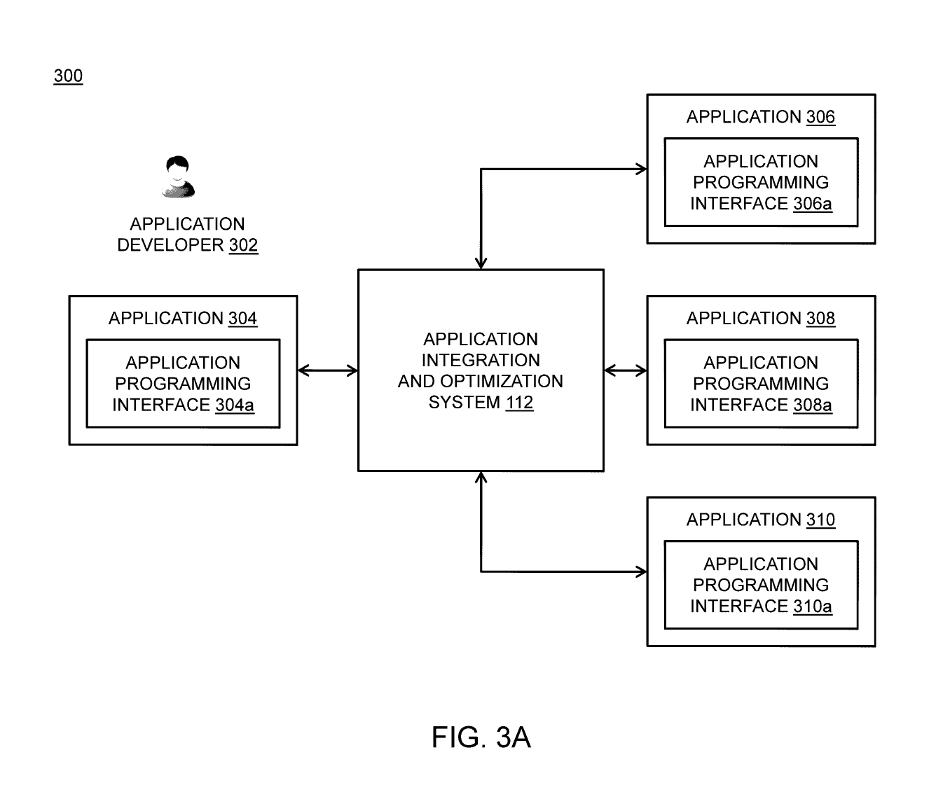

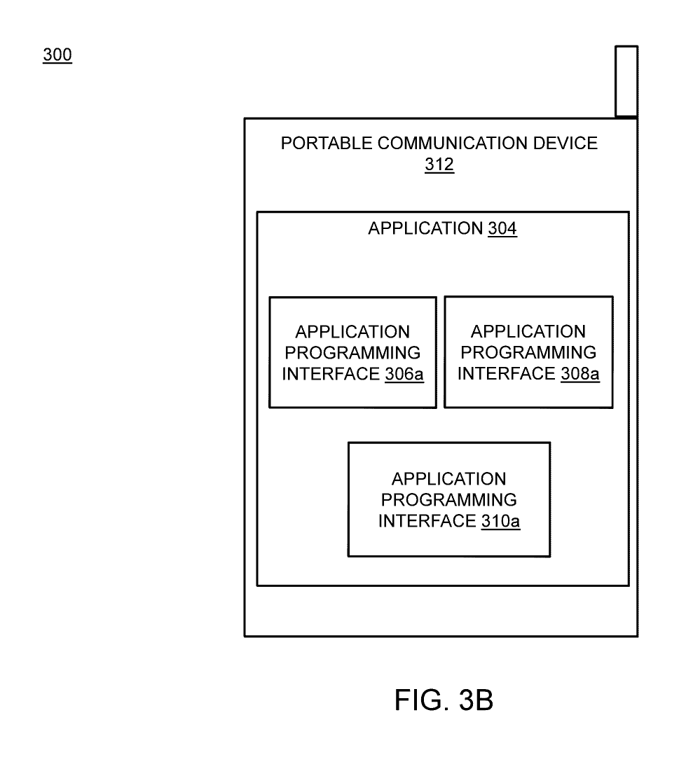

FIG. 3A illustrates a block diagram 300 for showing an example of the association of the recommended one or more application programming interfaces based on the optimization of the plurality of parameters, in accordance with various embodiments of the present disclosure. It may be noted that to explain the system elements of FIG. 3A, references will be made to the system elements of FIG. 1A, FIG. 1B and FIG. 2. The block diagram 300 includes an application 304, an application 306, an application 308, an application 310 and the application integration and optimization system 112.

The application 304 is associated with an application developer 302. Further, the application 304 is associated with an application programming interface 304a, the application 306 is associated with an application programming interface 306a, the application 308 is associated with an application programming interface 308a and the application 310 is associated with an application programming interface 310a. In addition, the application developer 302 accesses the application integration and optimization system 112 provides the one or more inputs for the plurality of parameters associated with the application 302.

Accordingly, the application integration and optimization system 112 optimizes the plurality of parameters provided by the application developer 302. Further, the application integration and optimization system 112 recommends the application programming interface 306a, the application programming interface 308a and the application programming interface 310a to the application developers 302 for the association with the application programming interface 304a. Further, the application integration and optimization system 112 cross links the application programming interface 304a with the application programming interface 306a, the application programming interface 308a and the application programming interface 310a.

FIG. 3B illustrates a portable communication device 312 for showing the association of the recommended one or more of application programming interfaces based on the optimization of the plurality of parameters, in accordance with various embodiments of the present disclosure. It may be noted that to explain the system elements of FIG. 3B, references will be made to the system elements of FIG. 1A, FIG. 1B, FIG. 2 and FIG. 3A. The portable communication device 312 includes the application 312 installed on the portable communication device 312. In addition, the portable communication device 312 includes a smart phone, a tablet, a laptop and the like. In an embodiment of the present disclosure, the portable communication device 312 is associated with a specific type of operating system.

Going further, the application programming interface 304a associated with the application 304 is linked with the recommended application programming interface 306a, the recommended application programming interface 308a and the recommended application programming interface 310a. In addition, the application 312 is accessed by the user of the plurality of users presently in any location and on a specified time for requesting any service. The application integration and optimization system 112 displays the services of each of the application 306, the application 308 and the application 310 integrated on the application 304 on a screen of the portable communication device 312. The user may choose services from any application based on his/her choice.

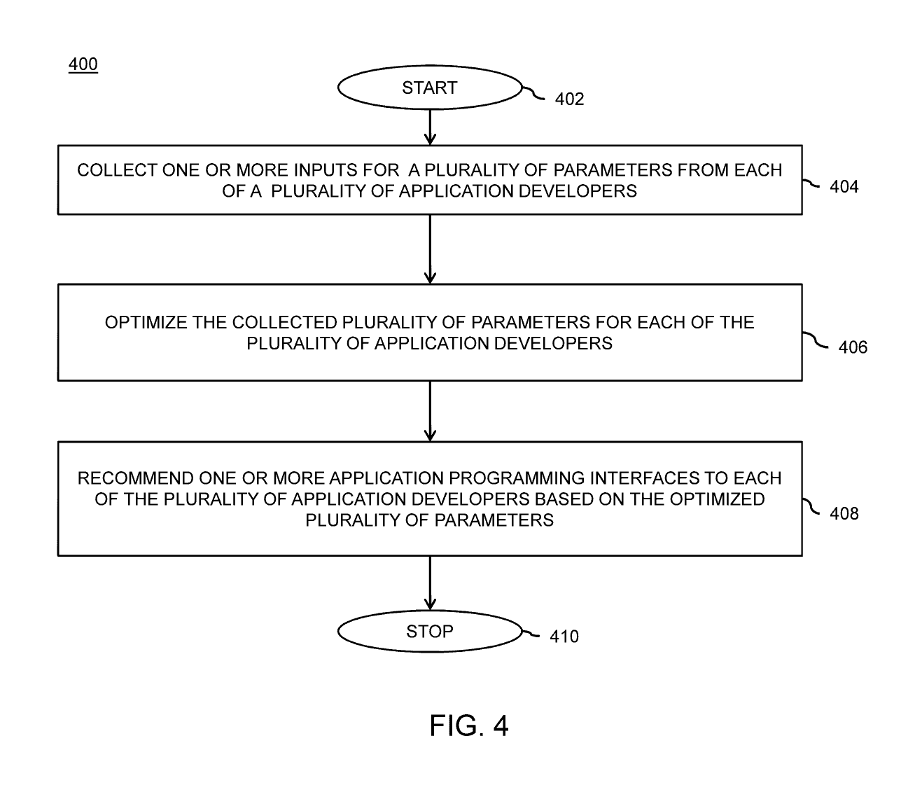

FIG. 4 illustrates a flowchart 400 for the optimization of the plurality of parameters associated with the plurality of applications 104, in accordance with various embodiments of the present disclosure. It may be noted that to explain the process steps of the flowchart 400, references will be made to the system elements of the FIG. 1A, FIG. 1B and FIG. 2. The flowchart 400 initiates at step 402. At step 404, the collection module 204e collects the one or more inputs for the plurality of parameters from each of the plurality of application developers 102. At step 406, the optimization engine 204f optimizes the collected plurality of parameters for each of the plurality of application developers 102. At step 408, the recommendation engine 204h recommends the one or more application programming interfaces to each of the plurality of application developers 102 based on the optimized plurality of parameters. The flowchart 400 terminates at step 410.

It may be noted that the flowchart 400 is explained to have above stated process steps; however, those skilled in the art would appreciate that the flowchart 400 may have more/less number of process steps which may enable all the above stated embodiments of the present disclosure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for optimization of a plurality of parameters associated with a plurality of applications, the plurality of parameters being optimized by a plurality of application developers, the computer-implemented method comprising:
collecting, with a processor, one or more inputs for the plurality of parameters from each of the plurality of application developers, wherein the one or more inputs being collected in real time;
optimizing, with the processor, the collected plurality of parameters for each of the plurality of application developers, wherein the optimization being done for allowing each of the plurality of application developers to define one or more preferences associated with the plurality of parameters; and
recommending, with the processor, one or more application programming interfaces associated with corresponding one or more applications of the plurality of applications to each of the plurality of application developers based on the optimized plurality of parameters, wherein the recommending being done in the real time.

2. The computer-implemented method as recited in claim 1, further comprising associating, with the processor, the recommended one or more application programming interfaces with an application programming interface associated with each of the plurality of application developers.

3. The computer-implemented method as recited in claim 2, wherein an application programming interface associated with a first category of application being associated with a recommended plurality of application programming interfaces associated with a plurality of categories of applications, wherein the first category of application being distinct from each of the plurality of categories of application and wherein the association being done based on a choice of each of the plurality of application developers.

4. The computer-implemented method as recited in claim 1, further comprising determining, with the processor, the one or more application programming interfaces based on the optimized plurality of parameters.

5. The computer-implemented method as recited in claim 1, further comprising registering, with the processor, each of the plurality of application developers, wherein the registering being done for allowing each of the plurality of application developers to provide the one or more inputs.

6. The computer-implemented method as recited in claim 1, further comprising receiving, with the processor, the application programming interface associated with each of the plurality of applications, wherein the application programming interface being received from a corresponding application server of a plurality of application servers and wherein the receiving being done for unifying the application programming interface associated with each of the plurality applications.

7. The computer-implemented method as recited in claim 1, further comprising classifying, with the processor, the application programming interface associated with each of the plurality of applications into a corresponding category of application of one or more categories of applications associated with the corresponding plurality of applications.

8. The computer-implemented method as recited in claim 1, wherein the plurality of parameters comprises a range of price associated with one or more services associated with each of the plurality of applications, a range of timings between which the one or more services associated with each of the plurality of applications being available and one or more locations at which the one or more services associated with each of the plurality of applications being available.

9. The computer-implemented method as recited in claim 1, wherein each of the plurality of parameters being defined by an administrator.

10. The computer-implemented method as recited in claim 1, further comprising storing, with the processor, the application programming interface associated with each of the plurality of applications, a registration information associated with each of the plurality of application developers, each of the classified application programming interfaces, each of the recommended one or more application programming interfaces, each of the associated application programming interfaces and the collected one or more inputs associated with the plurality of parameters.

11. A computer-program product for optimization of a plurality of parameters associated with a plurality of applications, the plurality of parameters being optimized by a plurality of application developers, the computer-program product comprising:
a computer readable storage medium having a computer program stored thereon for performing the steps of:
collecting one or more inputs for the plurality of parameters from each of the plurality of application developers, wherein the one or more inputs being collected in real time;
optimizing the collected plurality of parameters for each of the plurality of application developers, wherein the optimization being done for allowing each of the plurality of application developers to define one or more preferences associated with the plurality of parameters; and
recommending one or more application programming interfaces to each of the plurality of application developers based on the optimized plurality of parameters, wherein the recommending being done in the real time.

12. The computer-program product as recited in claim 11, further comprising associating the recommended one or more application programming interfaces with an application programming interface associated with each of the plurality of application developers.

13. The computer-program product as recited in claim 11, wherein an application programming interface associated with a first category of application being associated with a recommended plurality of application programming interfaces associated with a plurality of categories of applications, wherein the first category of application being distinct from each of the plurality of categories of application and wherein the association being done based on a choice of each of the plurality of application developers.

14. A system for optimization of a plurality of parameters associated with a plurality of applications, the plurality of parameters being optimized by a plurality of application developers, the system comprising:
a collection module in a processor, the collection module being configured for collecting one or more inputs for the plurality of parameters from each of the plurality of application developers, wherein the one or more inputs being collected in real time;
an optimization engine in the processor, the optimization engine being configured for optimizing the collected plurality of parameters for each of the plurality of application developers, wherein the optimization being done for allowing each of the plurality of application developers to define one or more preferences associated with the plurality of parameters; and
a recommendation engine in the processor, the recommendation engine being configured for recommending one or more application programming interfaces to each of the plurality of application developers based on the optimized plurality of parameters, wherein the recommending being done in the real time.

15. The system as recited in claim 14, further comprising an association module in the processor, the association module being configured for associating the recommended one or more application programming interfaces with an application programming interface associated with each of the plurality of application developers.

16. The system as recited in claim 14, further comprising a determination module in the processor, the determination module being configured for determining the one or more application programming interfaces based on the optimized plurality of parameters.

17. The system as recited in claim 14, further comprising a registration module in the processor, the registration module being configured for registering each of the plurality of application developers, wherein the registering being done for allowing each of the plurality of application developers to provide the one or more inputs.

18. The system as recited in claim 14, further comprising a receiving module in the processor, the receiving module being configured for receiving the application programming interface associated with each of the plurality of applications, wherein the application programming interface being received from a corresponding application server of a plurality of application servers and wherein the receiving being done for unifying the application programming interface associated with each of the plurality applications.

19. The system recited in claim 14, further comprising a classification engine in the processor, the classification engine being configured for classifying the application programming interface associated with each of the plurality of applications into a corresponding category of application of one or more categories of applications associated with the corresponding plurality of applications.

20. The system as recited in claim 14, further comprising a database in the processor, the database being configured for storing the application programming interface associated with each of the plurality of applications, a registration information associated with each of the plurality of application developers, each of the classified application programming interface, each of the recommended one or more application programming interfaces, each of the associated application programming interfaces and the collected one or more inputs associated with the plurality of parameters.
